(19) United States
(12) Patent Application Publication
(10) Pub. No.: US 2022/0345906 A1
(43) Pub. Date: Oct. 27, 2022

(54) USER EQUIPMENT AND COMMUNICATION METHOD

(71) Applicant: NTT DOCOMO, INC., Tokyo (JP)

(72) Inventors: Yuichi Kakishima, Chiyoda-ku, Tokyo (JP); Takuma Takada, Chiyoda-ku, Tokyo (JP)

(73) Assignee: NTT DOCOMO, INC., Tokyo (JP)

(21) Appl. No.: 17/754,288

(22) PCT Filed: Oct. 3, 2019
(86) PCT No.: PCT/JP2019/039223

§ 371 Date: Mar. 29, 2022

(51) Int. Cl. H04W 16/28; H04W 72/12

(52) U.S. Cl. CPC H04W 16/28; H04W 72/1263; H04W 72/1289

(57) ABSTRACT

A terminal includes a receiving unit that receives scheduling information; and a control unit that continues, in a case where the receiving unit receives the scheduling information within a delay time for switching a maximum number of Multiple-Input and Multiple-Output (MIMO) layers, an operation for switching the maximum number of MIMO layers and ignores the scheduling information.

### TECHNICAL FIELD

The present invention relates to a user equipment and a communication method in a radio communication system.

### BACKGROUND ART

At the meeting of 3GPP Release 16, there has been a discussion on reducing the power consumption of a terminal by limiting the maximum number of Multiple-Input and Multiple-Output (MIMO) layers. Regarding the limitation on the maximum number of MIMO layers, in downlink, it is considered that, by reducing the maximum number of receiving layers of the terminal, the power consumption of the terminal can be reduced, since the number of operating standby receiving circuits can be reduced. For example, in a terminal having four receiving circuits, by limiting the maximum number of receiving layers to one, the operation mode of up to three receiving circuits can be set to the sleep mode.

In addition, in the uplink, by limiting the maximum number of transmitting layers of the terminal, the power consumption of the terminal can be reduced, since the number of the operating transmitting circuits is reduced. For example, in a terminal having four transmitting circuits, by limiting the maximum number of transmitting layers to one, the operating mode of up to three transmitting circuits can be set to the sleep mode. For example, the above-described maximum number of the MIMO layers to be applied to the terminal may be indicated to the terminal by the base station (network).

### RELATED ART DOCUMENT

### Non-Patent Document

Non-Patent Document 1: 3GPP TS 38.133 V15.6.0 (2019-06)

### SUMMARY OF THE INVENTION

### Problem to be Solved by the Invention

As described above, in order to reduce the power consumption of the terminal, it is expected that the terminal changes the maximum number of the MIMO layers. There is a need for a method of stabilizing an operation for changing the maximum number of the MIMO layers in the terminal.

### Means for Solving the Problem

According to an aspect of the present invention, there is provided a terminal including a receiving unit that receives scheduling information; and a control unit that continues, in a case where the receiving unit receives the scheduling information within a delay time for switching a maximum number of Multiple-Input and Multiple-Output (MIMO) layers, an operation for switching the maximum number of MIMO layers and ignores the scheduling information.

### Advantage of the Invention

According to an embodiment, a method for stabilizing an operation for changing the maximum number of MIMO layers in a terminal is provided.

### BRIEF DESCRIPTION OF DRAWINGS

FIG. 1 is a configuration diagram of a communication system in the present embodiment.

FIG. 2 is a diagram illustrating an example of BWP Switching.

FIG. 3 is a diagram illustrating an example of the maximum delay time until the completion of BWP switching.

FIG. 4 is a diagram illustrating an example of Interruption length.

FIG. 5 is a diagram illustrating an example of ServingCellConfig that is an information element defined in Release 15.

FIG. 6 is a diagram illustrating a detailed example of PDSCH-ServingCellConfig.

FIG. 7 is a diagram illustrating an example in which PDSCH-Config is included in a BWP information element.

FIG. 8 is a diagram illustrating an example of a functional configuration of a base station.

FIG. 9 is a diagram illustrating an example of the functional configuration of a terminal.

FIG. 10 is a diagram illustrating an example of the hardware configuration of the base station and the terminal.

### EMBODIMENTS OF THE INVENTION

In the following, embodiments of the present invention are described with reference to the drawings. The embodiments described below are merely examples, and embodiments to which the present invention is applied are not limited to the following embodiments.

In the embodiments of the present invention described below, terms used in existing LTE are used, such as Synchronization Signal (SS), Primary SS (PSS), Secondary SS (SSS), Physical Broadcast channel (PBCH), and Physical Random Access channel (PRACH). This is for convenience of description, and signals and functions similar to these may be referred to by other names. The above-described terms in NR correspond to NR-SS, NR-PSS, NR-SSS, NR-PBCH, NR-PRACH, and the like. However, even if a signal is used for NR, the signal is not always explicitly indicated as “NR-.”

In embodiments of the present invention, a duplex method may be a Time Division Duplex (TDD) method, a Frequency Division Duplex (FDD) method, or any other method (e.g., Flexible Duplexing).

In the embodiments of the present invention, “configuring” a radio parameter or the like may be “pre-configuring” a predetermined value, or configuring a radio parameter transmitted from a base station 10 or a terminal 20.

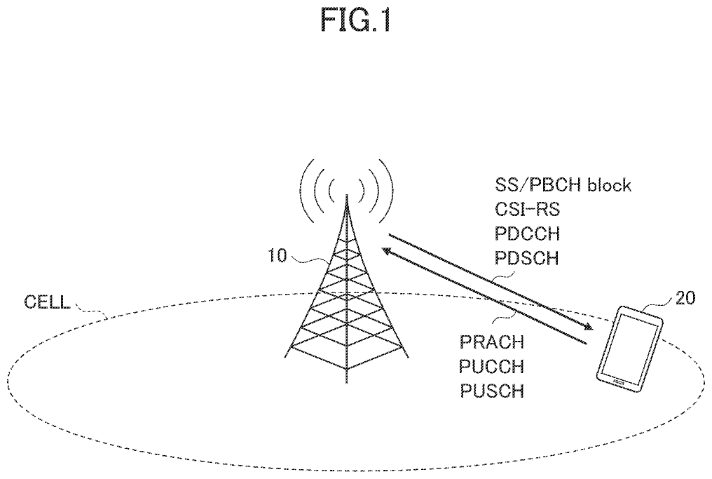

FIG. 1 is a diagram illustrating a radio communication system according to an embodiment of the present invention. The radio communication system according to the embodiment of the present invention includes the base station 10 and the terminal 20, as illustrated in FIG. 1. In FIG. 1, one base station 10 and one terminal 20 are illustrated. However, this is an example, and there may be a plurality of base stations 10, and there may be a plurality of terminals 20.

The base station 10 is a communication device that provides one or more cells and performs radio communication with the terminal 20. A physical resource of a radio signal is defined in a time domain and a frequency domain, the time domain may be defined by a number of OFDM symbols, and the frequency domain may be defined by a number of subcarriers or a number of resource blocks. The base station 10 transmits a synchronization signal and system information to the terminal 20. A synchronization signal is, for example, NR-PSS and NR-SSS. A part of system information is transmitted, for example, by NR-PBCH, which is also called broadcast information. A synchronization signal and broadcast information may be periodically transmitted as an SS block (SS/PBCH block) consisting of a predetermined number of OFDM symbols. For example, the base station 10 transmits a control signal or data in Downlink (DL) to the terminal 20 and receives a control signal or data in Uplink (UL) from the terminal 20. The base station 10 and the terminal 20 are capable of transmitting and receiving signals while performing beamforming. For example, as illustrated in FIG. 1, a reference signal transmitted from the base station 10 includes a Channel State Information Reference Signal (CSI-RS), and a channel transmitted from the base station 10 includes Physical Downlink Control Channel (PDCCH) and Physical Downlink Shared Channel (PDSCH).

The terminal 20 is a communication device provided with a radio communication function, such as a smartphone, a cellular phone, a tablet, a wearable terminal, and a communication module for Machine-to-Machine (M2M). The terminal 20 utilizes various communication services provided by a radio communication system by receiving a control signal or data in DL from the base station 10 and transmitting a control signal or data in UL to the base station 10. For example, as illustrated in FIG. 1, channels transmitted from the terminal 20 include Physical Uplink Control Channel (PUCCH) and Physical Uplink Shared Channel (PUSCH).

In the New Radio (NR), in order to secure coverage for communications using radio waves in a high frequency band, beamforming is applied to transmission of data in a Physical Downlink Shared Channel (PDSCH), transmission of a control signal in a Physical Downlink Control Channel (PDCCH), transmission of a synchronization signal and broadcast information in a Synchronization Signal/Physical Broadcast Channel (SS/PBCH) Block (SSB), and transmission of a reference signal (Channel State Information Signal (CSI-RS)/Demodulation Reference Signal (DMRS)).

For example, in Frequency Range 2 (FR2), i.e., in a frequency band of millimeter wave higher than or equal to 24 GHz, 64 beams can be used, and in Frequency Range 1 (FR1), i.e., in a sub-6 GHz frequency band, 8 beams can be used.

(UE Power Saving)

At the meeting of 3GPP Release 16, there has been a discussion on reducing the power consumption of the terminal 20 by limiting the maximum number of Multiple-Input and Multiple-Output (MIMO) layers. Regarding the limitation on the maximum number of MIMO layers, in downlink, it is considered that, by reducing the maximum number of receiving layers of the terminal, the power consumption of the terminal 20 can be reduced, since the number of operating standby receiving circuits can be reduced. For example, in a terminal having four receiving circuits, by limiting the maximum number of receiving layers to one, the operation mode of up to three receiving circuits can be set to the sleep mode. Note that the maximum number of MIMO layers, the maximum number of receiving layers, and the maximum number of transmitting layers may be the number of MIMO layers, the number of receiving layers, and the number of transmitting layers, respectively.

In addition, in the uplink, by limiting the maximum number of transmitting layers of the terminal 20, the power consumption of the terminal 20 can be reduced, since the number of the operating transmitting circuits is reduced. For example, in the terminal 20 having four transmitting circuits, by limiting the maximum number of transmitting layers to one, the operating mode of up to three transmitting circuits can be set to the sleep mode.

For example, the above-described maximum number of the MIMO layers to be applied to the terminal 20 may be indicated to the terminal by the base station 10 (network).

(BWP Switching)

In 3GPP Release 15 NR, a Bandwidth part operation is specified to dynamically switch a bandwidth for a transmission and a reception by the terminal 20. A bandwidth part is said to be a subset of adjacent common resource blocks.

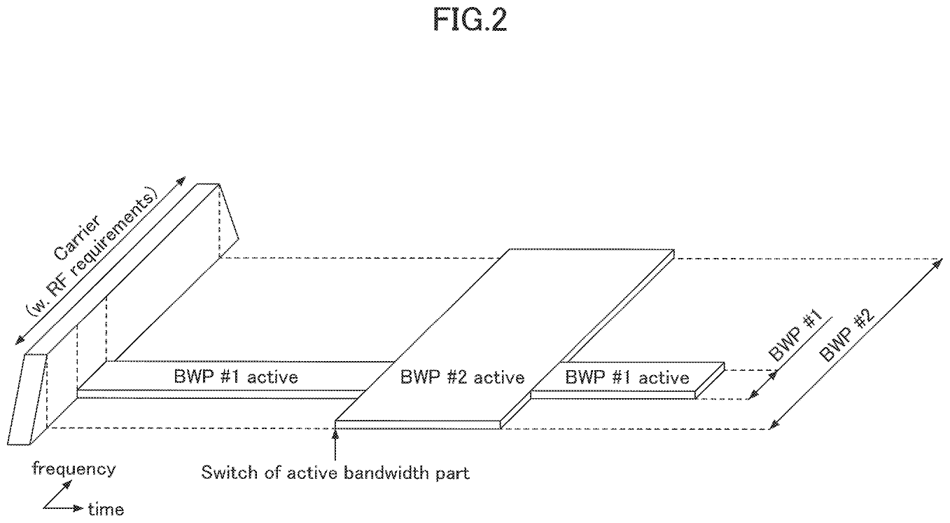

FIG. 2 is a diagram illustrating an example of BWP Switching. On the base station 10 side, it is possible to transmit a signal on the entire bandwidth illustrated as Carrier in FIG. 2. In this case, if a signal is always received in the entire bandwidth on the terminal 20 side, the power consumption of the terminal 20 may increase. Accordingly, the terminal 20 can narrow the bandwidth for receiving. In the example of FIG. 2, the terminal 20 receives a signal in the narrow bandwidth indicated as BWP #1 at the first timing. The terminal 20 can switch an active BWP. In the example of FIG. 2, the terminal 20 switches the active BWP to BWP #2 at the timing indicated as “Switch of active bandwidth part.” Subsequently, the terminal 20 switches the active BWP to BWP #1 again.

In the downlink, the base station 10 can configure up to four bandwidth parts (bandwidth, frequency position, subcarrier spacing, and the like) for the terminal 20 by using higher layer signaling. In this case, a single downlink bandwidth part is activated at each time. The terminal 20 receives a Physical Downlink Shared Channel (PDSCH), PDCCH, or Channel State Information Reference Signal (CSI-RS) within the active bandwidth part. That is, it is not expected that a PDSCH, a PDCCH, and a CSI-RS are transmitted outside the active bandwidth part.

In addition, in the uplink, the base station 10 can configure up to four bandwidth parts (bandwidth, frequency position, subcarrier spacing, and the like) for the terminal 20 by using higher layer signaling. In this case, a single uplink bandwidth part is activated at each time. When a supplementary uplink (Supplementary uplink, SUL) is configured for the terminal 20, the base station 10 can additionally configure up to four bandwidth parts for the terminal 20 in the supplementary uplink. In this case, a single additional uplink bandwidth part is activated at each time. The terminal 20 does not transmit a Physical Uplink Shared Channel (PUSCH) and a Physical Uplink Control Channel (PUCCH) outside the active bandwidth part. That is, the terminal 20 transmits a PUSCH or a PUCCH within an active bandwidth part.

BWP switching is performed, for example, in the following three patterns.

(Pattern 1)

The base station 10 can switch the BWP to be configured for the terminal 20 by Downlink Control Information (DCI). The base station 10 can indicate to the terminal 20 to switch an active DL/UL BWP by using DCI format1_1 or DCI format0_1.

(Pattern 2)

The base station 10 can switch the BWP to be configured for the terminal 20 by using higher layer signaling. For example, the base station 10 can switch the BWP to be configured for the terminal 20 by using a Radio Resource Control (RRC) Reconfiguration message.

(Pattern 3)

Furthermore, after the BWP is configured for the terminal 20, if no signal is received by the terminal until the bwp-InactivityTimer expires, the terminal 20 may switch the active BWP to the default BWP after the expiration of the bwp-InactivityTimer.

Furthermore, many NR RRC parameters are configured on a per BWP basis. In other words, it is possible to switch many radio parameters on a per BWP basis. For example, the base station 10 can change the subcarrier spacing (SCS: Subcarrier Spacing) applied to the terminal 20 on a per BWP basis.

In particular, it is expected that the above-described maximum number of MIMO layers applied by the terminal 20 is configured as a part of the active bandwidth part (BWP) switching. For example, in the example of FIG. 2, switching may be performed such that the terminal 20 sets 1 as the maximum number of MIMO layers for BWP #1 and the terminal 20 sets 4 as the maximum number of MIMO layers for BWP #2.

(BWP Switching Delay)

In 3GPP Release 15, the maximum delay time (delay) until the terminal 20 completes BWP switching is specified. That is, the terminal 20 is required to complete the BWP switching within a time shorter than the maximum delay time. For each of the above-described three patterns of the BWP switching, the maximum delay time until the completion of the BWP switching is specified.

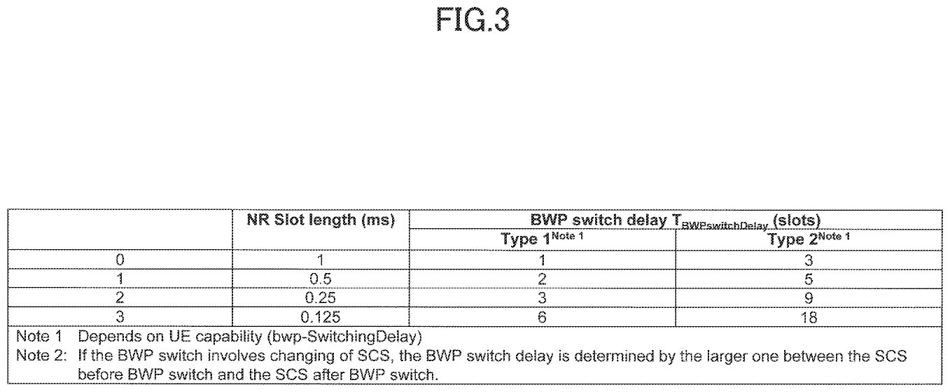

FIG. 3 illustrates an example of the maximum delay time until the completion of the BWP switching, which is allowed for the terminal 20, in a case where the BWP is switched by the DCI and in a case where the BWP is switched by the Inactivity Timer. In the example of FIG. 3, when the BWP is to be switched by the DCI, after the terminal 20 receives a request for the BWP switching in a downlink (DL) slot n, the terminal 20 should be able to perform a PDSCH reception (in the case of switching of a downlink (DL) active BWP) or a PUSCH transmission (in the case of switching of an uplink (UL) active BWP) in the BWP after the switching immediately after the start of DL slot n+T_{BWPswitchDelay}. That is, the terminal 20 is allowed not to transmit a UL signal or receive a DL signal during the time interval T_{BWPswitchDelay}. In the example of FIG. 3, similar to the case of switching the BWP by the DCI, when the BWP is to be switched by the Inactivity Timer, after the expiration of the Inactivity Timer, the terminal 20 is allowed not to transmit a UL signal or not to receive a DL signal during the time interval T_{BWPswitchDelay}.

In addition, it is specified that, when the BWP is to be switched by using the RRC Reconfiguration message, if an indication to switch the BWP is received by the RRC Reconfiguration message in a certain slot n, the terminal 20 should be able to receive PDSCH/PDCCH or transmit PUSCH in the switched BWP immediately after the start of DL slot n+(T_{RRCprocessingDelay}+T_{BWPswitchDelayRRC})/(NR Slot length). Here, T_{RRCprocessingDelay} is the length of the delay time of RRC processing, T_{BWPswitchDelayRRC} is 6 ms, and the terminal 20 is allowed not to perform data transmission/reception during T_{RRCprocessingDelay}+T_{BWPswitchDelayRRC}.

(Interruption Due to BWP Switching)

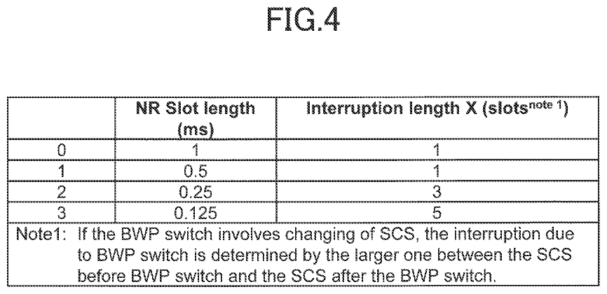

“Interruption” means that scheduling for a carrier (another component carrier or the like) other than a carrier to which the BWP switching is to be applied is restricted, which is not the carrier of the BWP to be switched. FIG. 4 is a diagram illustrating an example of the Interruption length. During the Interruption length X (slots) illustrated in FIG. 4, for example, even if the base station 10 has performed scheduling for the terminal 20, it is not expected that the terminal 20 operates according to the scheduling of the base station 10.

The Interruption largely depends on the implementation of a radio circuit of the terminal 20. A parameter called Per-FR gap is known as a parameter related to the implementation of a radio circuit of the terminal 20. For example, a case where the terminal 20 includes a radio circuit that operates in common for Frequency Range 1 (FR1) and Frequency Range 2 (FR2) may be the case of not supporting Per-FR gap. Furthermore, for example, it may be specified that, when the terminal 20 independently includes an FR1 radio circuit and an FR2 radio circuit, the terminal 20 supports the Per-FR gap. When the terminal 20 does not support the Per-FR gap, it is expected that the Interruption of X slots illustrated in the example of FIG. 4 may occur on all serving cells. In contrast, when the terminal 20 supports the Per-FR gap, it is expected that there is a case where the Interruption of X slots illustrated in the example of FIG. 4 occurs on a serving cell in an FR that is the same as that of the component carrier to which BWP switching is to be applied.

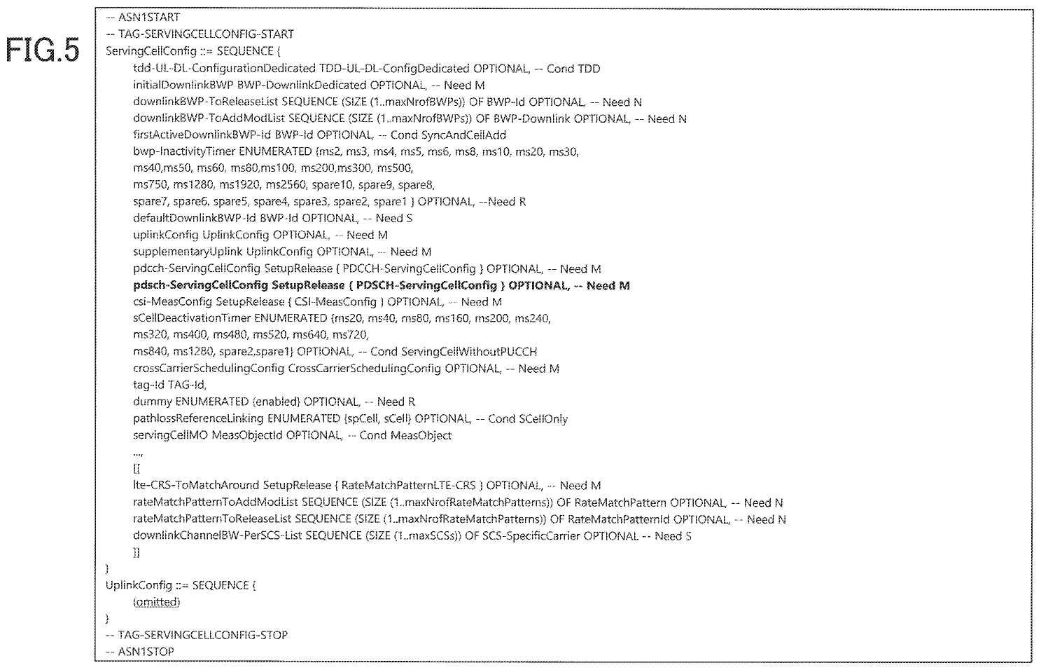

FIG. 5 is a diagram illustrating an example of ServingCellConfig that is an information element specified in Release 15. ServingCellConfig is an information element for providing a notification of a basic radio parameter of the serving cell. The ServingCellConfig illustrated in the example of FIG. 5 includes PDSCH-ServingCellConfig called pdsch-ServingCellConfig SetupRelease, that is, information indicating the configuration of the downlink data channel.

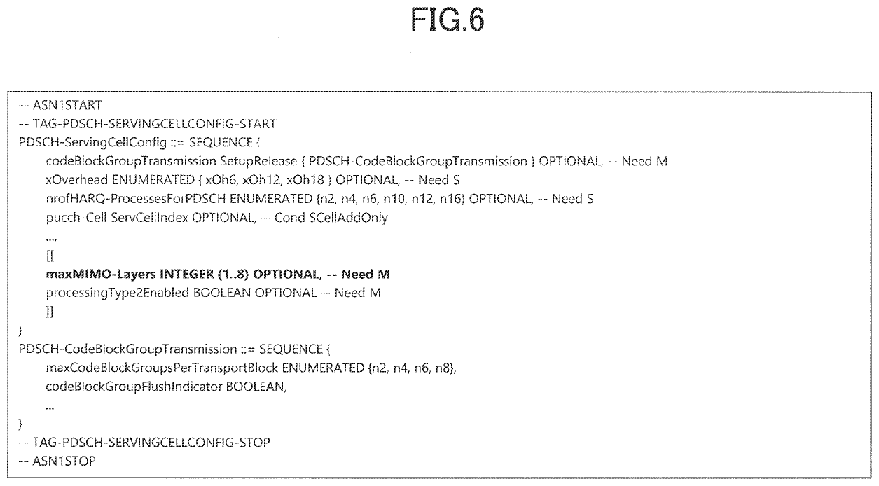

FIG. 6 is a diagram illustrating a detailed example of PDSCH-ServingCellConfig. As illustrated in the example of FIG. 6, PDSCH-ServingCellConfig includes maxMIMO-Layer. In the example of FIG. 6, maxMIMO-Layer can be configured for each PDSCH-ServingCellConfig. That is, in this case, maxMIMO-Layer is common to a plurality of BWPs, and is not expected to be specified on a per BWP basis.

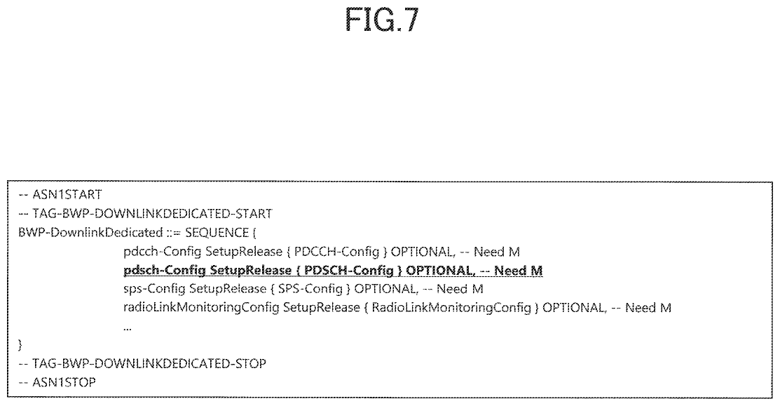

In contrast, in Release 16, for example, as illustrated in FIG. 7, the inclusion of PDSCH-Config as a parameter of the BWP information element has been studied, more specifically, the inclusion of the maxMIMO-Layers under the BWP information element has been studied. For this reason, it is expected that maxMIMO-Layers are configured on a per BWP basis.

(Problem)

As described above, in order to reduce the power consumption of the terminal 20, it is expected that the terminal 20 switches the maximum number of MIMO layers. For example, when the base station 10 schedules the terminal 20 while the terminal 20 is performing the operation of switching the maximum number of MIMO layers, it is unknown whether the terminal 20 continues the operation of switching the maximum number of MIMO layers or performs an operation corresponding to the scheduling from the base station 10. Accordingly, the operation of the terminal 20 may become unstable. In addition, since the base station 10 cannot determine whether it is allowed to schedule the terminal 20, it is expected that the scheduling becomes inefficient. A method of calculating the delay time is also unknown in a case where the maximum number of MIMO layers is to be changed.

In order to solve the above-described problem, a delay time (delay) for switching the maximum number of MIMO layers may be defined in the terminal 20. For example, it may be specified in a technical specification that the terminal 20 should complete the switching of the maximum number of MIMO layers within a specified delay time. In addition, even if the terminal 20 receives scheduling information from the base station 10 within the specified delay time, the terminal 20 may prioritize the operation of switching the maximum number of MIMO layers and ignore the scheduling information received from the base station 10.

According to the method described above, the terminal 20 completes the operation of switching the maximum number of MIMO layers within the specified delay time. Accordingly, even if the scheduling information is received from the base station 10 within the delay time, the operation of switching the maximum number of MIMO layers is preferentially performed. Accordingly, the operation of the terminal 20 is stabilized.

(Delay Requirements)

An example of delay time requirements for switching the maximum number of MIMO layers in the terminal 20 is described below. It is expected that the terminal 20 completes the switching of the maximum number of MIMO layers within the specified delay time.

For example, the delay time requirements for switching the maximum number of MIMO layers may be different among a case where switching of the maximum number of MIMO layers is indicated by the base station 10 by using DCI, a case where switching of the maximum number of MIMO layers is indicated by the base station 10 by using RRC signaling, and a case where switching is based on a timer.

For example, the delay time in a case where the switching of the maximum number of MIMO layers in the terminal 20 is indicated by the base station 10 by using the RRC signaling may be longer than or equal to the delay time in a case where the switching of the maximum number of MIMO layers is indicated by using the DCI. Furthermore, the delay time in a case where the switching of the maximum number of MIMO layers in the terminal 20 is indicated by the base station 10 by using the DCI may be longer than or equal to the delay time in a case where the switching of the maximum number of MIMO layers is performed based on the timer.

The delay time in a case where the switching of the maximum number of MIMO layers in the terminal 20 is indicated by the base station 10 by using the DCI may be specified as a delay time from the DCI that triggered the switching, for example. For example, the delay time may be specified as a delay time from the last symbol in which the DCI that triggered the switching is multiplexed.

In the case where the switching of the maximum number of MIMO layers in the terminal 20 is indicated by the base station 10 by using the DCI, it may be specified that, for example, a delay of T_{MaxMimoLayerSwitchDci} occurs.

For example, T_{MaxMimoLayerSwitchDci} may be defined as a sum of multiple delay times. For example, T_{MaxMimoLayerSwitchDci} may include one or both of T_{DciProcessing} that is a time required for the DCI processing and T_{SwitchDci} that is a delay time of Switching.

The delay time in a case where the switching of the maximum number of MIMO layers in the terminal 20 is indicated by the base station 10 by using RRC signaling may be defined, for example, as a delay time from the RRC signaling that triggered the switching. For example, the delay time may be specified as a delay time from the ACK transmission and reception timing for the RRC signaling.

In a case where the switching of the maximum number of MIMO layers in the terminal 20 is indicated by the base station 10 by using RRC signaling, it may be defined that, for example, a delay of T_{MaxMimoLayerSwitchRrc} occurs.

For example, T_{MaxMimoLayerSwitchRrc} may be defined as a sum of multiple delay times. For example, T_{MaxMimoLayerSwitchRrc} may include one or both of T_{RrcProcessing} that is a time required for the RRC processing and T_{SwitchRrc} that is a delay time of Switching.

The delay time in the case where the switching of the maximum number of MIMO layers in the terminal 20 is performed based on the timer may be defined as, for example, a delay time from the timing when the timer expires.

When the switching of the maximum number of MIMO layers in the terminal 20 is performed based on the timer, it may be specified that, for example, a delay of T_{MaxMimoLayerSwitchTimer} from the expiration of the timer occurs.

For example, T_{MaxMimoLayerSwitchSwitch} may be defined as a sum of multiple delay times. For example, T_{MaxMimoLayerSwitchSwitch} may include one or both of T_{TimerProcessing} that is a time required for processing of the timer and T_{SwitchRrc} that is the delay time of Switching.

For example, the delay time requirements for switching the maximum number of MIMO layers may be the same as the delay time requirements defined for BWP switching.

For example, the delay time requirements for switching the maximum number of MIMO layers may be different between a case where the maximum number of MIMO layers increases and a case where the maximum number of MIMO layers decreases. In general, it is expected that it takes longer time for stabilizing a radio circuit in a case of activation.

For example, the delay time for switching the maximum number of MIMO layers to increase the maximum number of MIMO layers may be longer than the delay time for switching the maximum number of MIMO layers for decreasing the maximum number of MIMO layers.

Alternatively, for example, the delay time for switching the maximum number of MIMO layers to reduce the maximum number of MIMO layers may be longer than the delay time for switching the maximum number of MIMO layers for increasing the maximum number of MIMO layers.

Furthermore, for example, the delay time requirements for BWP switching may be different between a case where the BWP bandwidth increases and a case where the BWP bandwidth decreases.

Furthermore, the change of the maximum number of MIMO layers may be controlled as active BWP switching.

For example, when active BWP switching is performed and when radio parameters other than the maximum number of MIMO layers are the same, a delay rule different from that of the existing active BWP switching delay may be applied. The delay may be longer than or shorter than the existing active BWP switching delay.

For example, when active BWP switching is performed and when only some radio parameters including the maximum number of MIMO layers is changed, a delay rule different from that of the existing active BWP switching delay may be applied. The delay may be longer than or shorter than the existing active BWP switching delay. For example, a more appropriate delay time may be obtained by defining the delay time according to the type of the radio parameter.

For example, the radio parameters described above may be one or both of baseband (BB) parameters and radio (RF) parameters.

Furthermore, for example, the radio parameters described above may include a center frequency (or frequency information corresponding thereto), BW, and SCS.

In order to reduce the power consumption of the terminal 20, it is expected to be effective to increase and decrease the maximum number of MIMO layers and the BWP parameter in pairs.

For example, in active BWP switching, it is assumed that the maximum number of MIMO layers and the BW are changed without changing the center frequency and SCS. When both the maximum number of MIMO layers and the BW are reduced, the requirements for the delay time may be relatively reduced. Furthermore, when one or both of the maximum number of MIMO layers and the BW are to be increased, the requirements for the delay time may be relatively enlarged.

(Method of Specifying Delay Requirement)

A delay requirement may be specified as scheduling restriction (a period during which the terminal 20 does not accept scheduling from the base station 10). Furthermore, the delay requirement may be specified as the Interruption time. The delay time (delay) may be specified as a period during which the terminal 20 does not accept scheduling from the base station 10. For example, it may be assumed that the terminal 20 does not expect an uplink transmission or a downlink reception during the delay time. For example, the delay time may specify a timing at which communication is allowed or disallowed in a state after switching the maximum number of MIMO layers.

The above-described delay time may be specified as the Interruption time. For example, the delay time for switching the maximum number of MIMO layers may be applied to a carrier other than the carrier including the switched BWP.

The Interruption may affect on a per BWP basis. For example, when Active BWP switching is performed, the Interruption may be applied to the BWP.

Furthermore, the Interruption may affect on a per carrier basis. For example, when Active BWP switching is performed, the Interruption may be applied to the BWP and a BWP included in the same carrier (however, in Release 15 NR, the number of active BWPs is limited to one).

In addition, the Interruption may affect on a per band basis. For example, when Active BWP switching is performed, the Interruption may be applied to the BWP and a carrier included in the same band.

Furthermore, the Interruption may affect on a per Frequency Range (FR) basis. For example, when Active BWP switching is performed, the Interruption may be applied to the BWP and a carrier included in the same FR. The Interruption may be applied to the terminal 20 that supports per-FR gap.

Furthermore, the Interruption may affect all bands. For example, the Interruption may be applied to the terminal 20 that does not support the per-FR gap. In addition, a common Interruption may be applied to all the terminals 20.

Note that the value of the delay time may be specified by a symbol, may be specified by a slot, or may be specified by an absolute time unit (ms or the like).

(Device Configuration)

Next, an example of the functional configuration of the base station 10 and the terminal 20 for performing the processes and operations described above is described. The base station 10 and the terminal 20 include functions for implementing the above-described embodiments. However, each of the base station 10 and the terminal 20 may include only some of the functions in the embodiments.

<Base Station Apparatus 10>

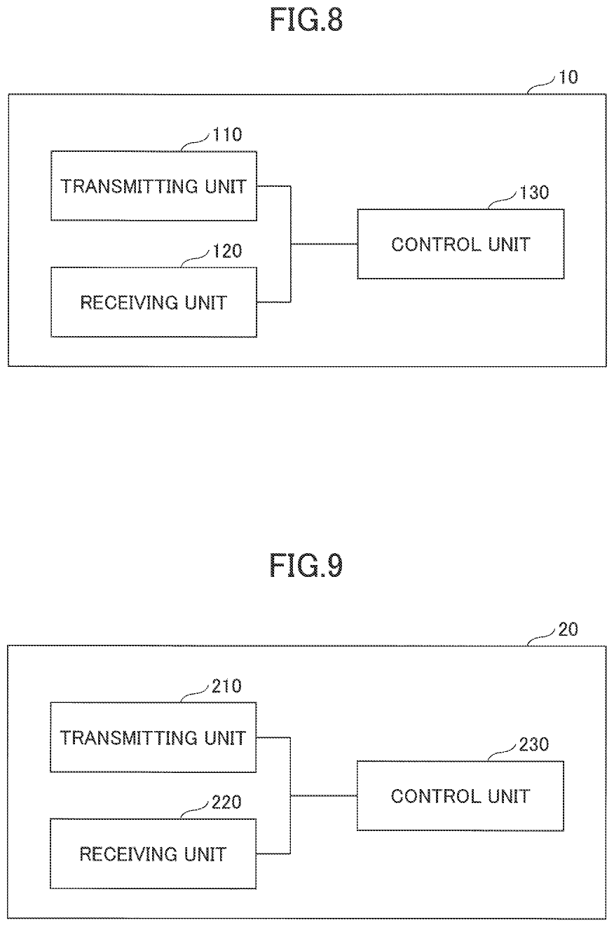

FIG. 8 is a diagram illustrating an example of the functional configuration of the base station 10. As illustrated in FIG. 8, the base station 10 includes a transmitting unit 110, a receiving unit 120, and a control unit 130. The functional configuration illustrated in FIG. 8 is merely one example. The functional division and names of functional units may be any division and names, provided that the operations according to the embodiments of the present invention can be performed.

The transmitting unit 110 includes a function for generating a transmit signal from transmit data, and the transmitting unit 110 transmits the transmit signal through radio. The receiving unit 120 receives various types of signals through radio, and the receiving unit 120 obtains a higher layer signal from the received physical layer signal. Furthermore, the receiving unit 120 includes a measurement unit that performs measurement of a received signal to obtain received power, and so forth.

The control unit 130 controls the base station 10. Note that a function of the control unit 130 related to transmission may be included in the transmitting unit 110 and a function of the control unit 130 related to reception may be included in the receiving unit 120.

The control unit 130 of the base station 10 generates instruction information for causing the terminal 20 to switch the BWP, and the transmitting unit 110 transmits the instruction information to the terminal 20. For example, the receiving unit 120 of the base station 10 may receive a signal including UE Capability from the terminal 20, and the control unit 130 may identify the delay time for the BWP switching of the terminal 20 based on the UE Capability and determine not to transmit scheduling information while the terminal 20 is performing the BWP switching operation. In addition, the control unit 130 of the base station 10 generates instruction information for causing the terminal 20 to switch the maximum number of MIMO layers, and the transmitting unit 110 transmits the instruction information to the terminal 20. For example, the receiving unit 120 of the base station 10 may receive a signal including UE Capability from the terminal 20, and the control unit 130 may identify the delay time for switching the maximum number of MIMO layers of the terminal 20 based on the UE Capability and determine not to transmit scheduling information while the terminal 20 is performing the operation of switching the maximum number of MIMO layers.

<Terminal 20>

FIG. 9 is a diagram illustrating an example of the functional configuration of the terminal 20. As illustrated in FIG. 9, the terminal 20 includes a transmitting unit 210, a receiving unit 220, and a control unit 230. The functional configuration illustrated in FIG. 9 is merely an example. The functional division and names of functional units may be any division and names, provided that the operation according to the embodiments can be performed.

The transmitting unit 210 includes a function for generating a signal to be transmitted to the base station 10 and transmitting the signal through radio. The receiving unit 220 includes a function for receiving various types of signals transmitted from the base station 10 and obtaining, for example, higher layer information from the received signals. The receiving unit 220 includes a measurement unit that measures a received signal to obtain a received power.

The control unit 230 controls the terminal 20. The function of the control unit 230 related to transmission may be included in the transmitting unit 210, and the function of the control unit 230 related to reception may be included in the receiving unit 220.

The control unit 230 of the terminal 20 completes the BWP switching within the delay time in which the BWP switching is allowed. Even if the receiving unit 220 receives scheduling information from the base station 10 within the delay time for BWP switching, the control unit 230 of the terminal 20 ignores the scheduling information and continues the BWP switching operation. The transmitting unit 210 of the terminal 20 may include the delay time for BWP switching in the UE Capability, and may receive a signal including the UE Capability. In addition, the control unit 230 of the terminal 20 completes the switching of the maximum number of MIMO layers within the delay time in which the switching of the maximum number of MIMO layers is allowed. Even if the receiving unit 220 receives scheduling information from the base station 10 within the delay time for switching the maximum number of MIMO layers, the control unit 230 of the terminal 20 ignores the scheduling information and continues the operation of switching the maximum number of MIMO layers. The transmitting unit 210 of the terminal 20 may include the delay time for switching the maximum number of MIMO layers in the UE Capability, and may transmit a signal including the UE Capability.

<Hardware Configuration>

The block diagrams (FIG. 8 to FIG. 9) used in describing the above embodiments show blocks of functional units. These functional blocks (components) are implemented by any combination of at least one of hardware and software. In addition, the implementation method of each functional block is not particularly limited. That is, each functional block may be implemented using a single device that is physically or logically combined, or may be implemented by directly or indirectly connecting two or more devices that are physically or logically separated (e.g., using wire or radio) and using these multiple devices. The functional block may be implemented by combining software with the above-described one device or the above-described plurality of devices. Functions include, but are not limited to, judgment, decision, determination, computation, calculation, processing, derivation, research, search, verification, reception, transmission, output, access, resolution, choice, selection, establishment, comparison, assumption, expectation, deeming, broadcasting, notifying, communicating, forwarding, configuring, reconfiguring, allocating, mapping, assigning, and so forth. For example, a functional block (component) that functions to transmit is called a transmitting unit or a transmitter. In either case, as described above, the implementation method is not particularly limited.

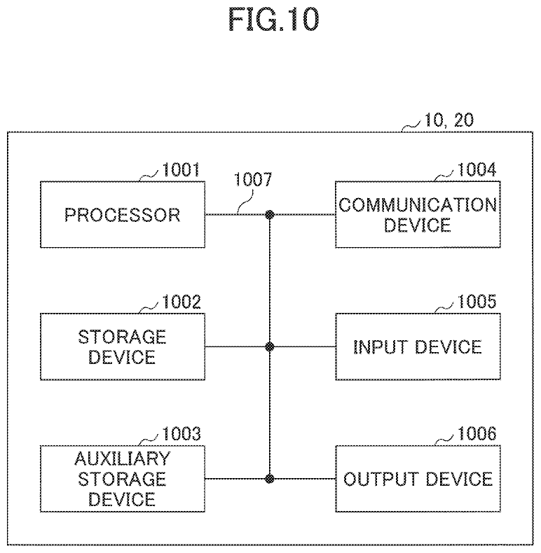

For example, the base station 10 and the terminal 20 according to an embodiment of the present invention may function as computers performing the process of the radio communication according to the embodiment of the present invention. FIG. 10 is a diagram illustrating an example of a hardware configuration of the base station 10 and the terminal 20 according to the embodiment. Each of the above-described base station 10 and terminal 20 may be physically configured as a computer device including a processor 1001, a storage device 1002, an auxiliary storage device 1003, a communication device 1004, an input device 1005, an output device 1006, a bus 1007, and so forth.

Note that, in the following description, the term “device” can be replaced with a circuit, a device, a unit, and so forth. The hardware configuration of the base station 10 and the terminal 20 may be configured to include one or more of the devices depicted in the figure, which are indicated by 1001 through 1006, or may be configured without some devices.

Each function of the base station 10 and the terminal 20 is implemented by loading predetermined software (program) on hardware, such as the processor 1001 and the storage device 1002, so that the processor 1001 performs computation and controls communication by the communication device 1004, and at least one of reading and writing of data in the storage device 1002 and the auxiliary storage device 1003.

The processor 1001, for example, operates an operating system to control the entire computer. The processor 1001 may be configured with a central processing unit (CPU: Central Processing Unit) including an interface with a peripheral device, a control device, a processing device, a register, and so forth.

Additionally, the processor 1001 reads a program (program code), a software module, data, or the like from at least one of the auxiliary storage device 1003 and the communication device 1004 to the storage device 1002, and executes various processes according to these. As the program, a program is used which causes a computer to execute at least a part of the operations described in the above-described embodiment. For example, the control unit 130 of the base station 10 may be implemented by a control program that is stored in the storage device 1002 and that is operated by the processor 1001. While the various processes described above are described as being executed in one processor 1001, they may be executed simultaneously or sequentially by two or more processors 1001. The processor 1001 may be implemented by one or more chips. The program may be transmitted from a network via a telecommunications line.

The storage device 1002 is a computer readable storage medium, and, for example, the storage device 1002 may be formed of at least one of a Read Only Memory (ROM), an Erasable Programmable ROM (EPROM), an Electrically Erasable Programmable ROM (EEPROM), a Random Access Memory (RAM), and the like. The storage device 1002 may be referred to as a register, a cache, a main memory (main storage device), or the like. The storage device 1002 may store a program (program code), a software module, and so forth, which can be executed for implementing the radio communication method according to the embodiments of the present disclosure.

The auxiliary storage device 1003 is a computer readable storage medium and may be formed of, for example, at least one of an optical disk, such as a Compact Disc ROM (CD-ROM), a hard disk drive, a flexible disk, an optical magnetic disk (e.g., a compact disk, a digital versatile disk, a Blu-ray (registered trademark) disk), a smart card, a flash memory (e.g., a card, a stick, a key drive), a floppy (registered trademark) disk, a magnetic strip, and so forth. The auxiliary storage device 1003 may be referred to as an auxiliary storage device. The above-described storage medium may be, for example, a database including at least one of the storage device 1002 and the auxiliary storage device 1003, a server, or any other suitable medium.

The communication device 1004 is hardware (transmitting and receiving device) for performing communication between computers through at least one of a wired network and a wireless network, and is also referred to, for example, as a network device, a network controller, a network card, a communication module, or the like. The communication device 1004 may be configured to include, for example, a high frequency switch, a duplexer, a filter, a frequency synthesizer, and the like, to implement at least one of frequency division duplex (FDD: Frequency Division Duplex) and time division duplex (TDD: Time Division Duplex).

The input device 1005 is an input device (e.g., a keyboard, mouse, microphone, switch, button, or sensor) that receives an external input. The output device 1006 is an output device (e.g., a display, speaker, or LED lamp) that implements an external output. The input device 1005 and the output device 1006 may have an integrated configuration (for example, a touch panel).

Each device, such as the processor 1001 and the storage device 1002, is also connected by the bus 1007 for communicating information. The bus 1007 may be formed of a single bus or may be formed of different buses between devices.

The base station 10 and the terminal 20 may each include hardware, such as a microprocessor, a digital signal processor (DSP: Digital Signal Processor), an Application Specific Integrated Circuit (ASIC), a Programmable Logic Device (PLD), and a Field Programmable Gate Array (FPGA), which may implement some or all of the functional blocks. For example, processor 1001 may be implemented using at least one of these hardware components.

### Conclusion of the Embodiments

In the present specification, at least the following user equipment and the communication method are disclosed.

A terminal including a receiving unit that receives scheduling information; and a control unit that continues, in a case where the receiving unit receives the scheduling information within a delay time for switching a maximum number of Multiple-Input and Multiple-Output (MIMO) layers, an operation for switching the maximum number of MIMO layers and ignores the scheduling information.

According to the above-described configuration, the terminal prioritizes the operation for switching the maximum number of MIMO layers, even if the scheduling information is received in the delay time for performing the operation for switching the maximum number of MIMO layers. Accordingly, the operation of the terminal is stabilized.

The delay time may be specified for each of a case where the switching of the maximum number of the MIMO layers is indicated by using Radio Resource Control (RRC) signaling, a case where the switching of the maximum number of the MIMO layers is indicated by using Downlink Control Information (DCI), and a case where the switching of the maximum number of the MIMO layers is performed based on a timer.

According to the above-described configuration, the delay time is specified for each of the case where the switching of the maximum number of the MIMO layers is indicated by using RRC signaling, the case where the switching of the maximum number of the MIMO layers is indicated by using the DCI, and the case where the switching of the maximum number of the MIMO layers is performed based on the timer, so that an optimum delay time can be set for each pattern.

The control unit may perform the operation to switch the maximum number of the MIMO layers as a part of an operation for switching a Bandwidth Part.

According to the above-described configuration, the delay time for switching the maximum number of MIMO layers can be included in the delay time for switching the BWP.

The delay time may be specified for each of a Frequency Range 1 (FR1) and a Frequency Range 2 (FR2). According to the above-described configuration, the delay time for switching the maximum number of MIMO layers for each of the case of the FR1 and the case of the FR2.

A communication method executed by a terminal, the method including receiving scheduling information; and continuing, in a case where the receiving receives the scheduling information within a delay time for switching a maximum number of Multiple-Input and Multiple-Output (MIMO) layers, an operation for switching the maximum number of MIMO layers and ignoring the scheduling information.

According to the above-described configuration, the terminal prioritizes the operation for switching the maximum number of MIMO layers, even if the scheduling information is received in the delay time for performing the operation for switching the maximum number of MIMO layers. Accordingly, the operation of the terminal is stabilized.

### Supplemental Embodiments

While the embodiments of the present invention are described above, the disclosed invention is not limited to the embodiments, and those skilled in the art will appreciate various alterations, modifications, alternatives, substitutions, etc. Descriptions are provided using specific numerical examples to facilitate understanding of the invention, but, unless as otherwise specified, these values are merely examples and any suitable value may be used. Classification of the items in the above descriptions is not essential to the present invention, and the items described in two or more items may be used in combination as needed, or the items described in one item may be applied to the items described in another item, provided that there is no contradiction. The boundaries of functional units or processing units in the functional block diagram do not necessarily correspond to the boundaries of physical components. An operation by a plurality of functional units may be physically performed by one component or an operation by one functional unit may be physically executed by a plurality of components. For the processing procedures described in the embodiment, the order of processing may be changed as long as there is no inconsistency. For the convenience of the description of the process, the base station 10 and the terminal 20 are described using functional block diagrams, but such devices may be implemented in hardware, software, or a combination thereof. Software operated by a processor included in the base station 10 in accordance with embodiments of the present invention and software operated by a processor included in the terminal 20 in accordance with embodiments of the present invention may be stored in a random access memory (RAM), a flash memory (RAM), a read-only memory (ROM), an EPROM, an EEPROM, a register, a hard disk (HDD), a removable disk, a CD-ROM, a database, a server, or any other suitable storage medium, respectively.

Notification of information is not limited to the aspects/embodiments described in the disclosure, and notification of information may be made by another method. For example, notification of information may be implemented by physical layer signaling (e.g., Downlink Control Information (DCI), Uplink Control Information (UCI), higher layer signaling (e.g., Radio Resource Control (RRC) signaling, Medium Access Control (MAC) signaling, broadcast information (Master Information Block (MIB), System Information Block (SIB))), or other signals or combinations thereof. RRC signaling may be referred to as an RRC message, for example, which may be an RRC connection setup message, an RRC connection reconfiguration message, or the like.

The aspects/embodiments described in this disclosure may be applied to a system using at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), W-CDMA (Registered Trademark), GSM (Registered Trademark), CDMA2000, Ultra Mobile Broadband (UWB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), any other appropriate system, and a next generation system extended based on theses. Additionally, a plurality of systems may be combined (e.g., a combination of at least one of LTE and LTE-A and 5G) to be applied.

The processing procedures, sequences, flow charts or the like of each aspect/embodiment described in this disclosure may be reordered, provided that there is no contradiction. For example, the methods described in this disclosure present elements of various steps in an exemplary order and are not limited to the particular order presented.

The particular operation described in this disclosure to be performed by the base station 10 may be performed by an upper node in some cases. It is apparent that in a network consisting of one or more network nodes having the base station 10, various operations performed for communicating with the terminal may be performed by at least one of the base station 10 and a network node other than the base station 10 (e.g., MME or S-GW can be considered, however, the network node is not limited to these). The case is exemplified above in which there is one network node other than the base station 10. However, the network node other than the base station 10 may be a combination of multiple other network nodes (e.g., MME and S-GW).

Input and output information, etc., may be stored in a specific location (e.g., memory) or managed using management tables. Input and output information may be overwritten, updated, or added. Output information may be deleted. The input information may be transmitted to another device.

The determination may be made by a value (0 or 1) represented by 1 bit, by a true or false value (Boolean: true or false), or by comparison of numerical values (e.g., a comparison with a predefined value).

The aspects/embodiments described in this disclosure may be used alone, in combination, or switched with implementation. Notification of predetermined information (e.g. “X” notice) is not limited to a method that is explicitly performed, and may also be made implicitly (e.g. “no notice of the predetermined information”).

Software should be broadly interpreted to mean, regardless of whether referred to as software, firmware, middleware, microcode, hardware description language, or any other name, instructions, sets of instructions, code, code segments, program code, programs, subprograms, software modules, applications, software applications, software packages, routines, subroutines, objects, executable files, executable threads, procedures, functions, etc.

Software, instructions, information, etc., may also be transmitted and received via a transmission medium. For example, when software is transmitted from a website, server, or other remote source using at least one of wireline technology (such as coaxial cable, fiber optic cable, twisted pair, digital subscriber line) and wireless technology (infrared, microwave, etc.), at least one of these wireline technology and wireless technology is included within the definition of a transmission medium.

The information, signals, etc., described in this disclosure may be represented using any of a variety of different techniques. For example, data, instructions, commands, information, signals, bits, symbols, chips, etc., which may be referred to throughout the above description may be represented by voltages, currents, electromagnetic waves, magnetic fields or magnetic particles, optical fields or photons, or any combination thereof.

The terms described in this disclosure and those necessary for understanding this disclosure may be replaced by terms having the same or similar meanings. For example, at least one of the channels and the symbols may be a signal (signaling). The signal may also be a message. Furthermore, a component carrier (CC: Component Carrier) may be referred to as a carrier frequency, a cell, a frequency carrier, or the like.

As used in this disclosure, the terms “system” and “network” are used interchangeably. The information, parameters, etc., described in the present disclosure may also be expressed using absolute values, relative values from predetermined values, or they may be expressed using corresponding separate information. For example, radio resources may be those indicated by an index.

The name used for the parameters described above are not restrictive in any respect. In addition, the mathematical equations using these parameters may differ from those explicitly disclosed in this disclosure. Since the various channels (e.g., PUCCH, PDCCH, etc.) and information elements can be identified by any suitable name, the various names assigned to these various channels and information elements are not in any way limiting.

In this disclosure, the terms “Base Station,” “Radio Base Station,” “Fixed Station,” “NodeB,” “eNodeB (eNB),” “gNodeB (gNB),” “Access Point,” “Transmission Point,” “Reception Point,” “Transmission/Reception Point,” “Cell,” “Sector,” “Cell Group,” “Carrier,” “Component Carrier,” etc., may be used interchangeably. The base stations may be referred to in terms such as macro-cell, small-cell, femto-cell, pico-cell, etc.

The base station can accommodate one or more (e.g., three) cells. Where the base station accommodates a plurality of cells, the entire coverage area of the base station can be divided into a plurality of smaller areas, each smaller area can also provide communication services by means of a base station subsystem (e.g., an indoor small base station (RRH) or a remote Radio Head). The term “cell” or “sector” refers to a portion or all of the coverage area of at least one of the base station and base station subsystem that provides communication services at the coverage.

In this disclosure, terms such as “mobile station (MS: Mobile Station)”, “user terminal”, “user equipment (UE: User Equipment)”, “terminal”, etc., may be used interchangeably.

The mobile station may be referred to by one of ordinary skill in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable term.

At least one of a base station and a mobile station may be referred to as a transmitter, a receiver, a communication device, or the like. At least one of a base station and a mobile station may be a device installed in a mobile body, a mobile body itself, etc. The mobile body may be a vehicle (e.g., a car, an airplane, etc.), an unmanned mobile (e.g., a drone, an automated vehicle, etc.), or a robot (manned or unmanned). At least one of a base station and a mobile station includes a device that does not necessarily move during communication operations. For example, at least one of a base station and a mobile station may be an Internet of Things (IoT) device such as a sensor.

In addition, the base station in the present disclosure may be replaced with the user terminal. For example, various aspects/embodiments of the present disclosure may be applied to a configuration in which communication between the base stations and the user terminal is replaced with communication between multiple user terminals (e.g., may be referred to as Device-to-Device (D2D), Vehicle-to-Everything (V2X), or the like). In this case, a configuration may be such that the above-described function of the base station 10 is included in the user terminal 20. The terms “up” and “down” may also be replaced with the terms corresponding to terminal-to-terminal communication (e.g., “side”). For example, an uplink channel, a downlink channel, etc., may be replaced with a sidelink channel. Similarly, the user terminal according to the present disclosure may be replaced with a base station. In this case, a configuration may be such that, the function included in the above-described user terminal 20 may be included in the base station 10.

The term “connected” or “coupled” or any variation thereof means any direct or indirect connection or connection between two or more elements and may include the presence of one or more intermediate elements between two elements “connected” or “coupled” with each other. The coupling or connection between the elements may be physical, logical, or a combination of these. For example, “connection” may be replaced with “access”. As used in the present disclosure, the two elements may be considered as being “connected” or “coupled” to each other using at least one of the one or more wires, cables, and printed electrical connections and, as a number of non-limiting and non-inclusive examples, electromagnetic energy having wavelengths in the radio frequency region, the microwave region, and the light (both visible and invisible) region.

The reference signal may be abbreviated as RS (Reference Signal) or may be referred to as a pilot, depending on the standards applied.

As used in this disclosure, the expression “based on” does not mean “based on only” unless otherwise specified. In other words, the expression “based on” means both “based on only” and “at least based on.”

As long as “include,” “including,” and variations thereof are used in this disclosure, the terms are intended to be inclusive in a manner similar to the term “comprising.” Furthermore, the term “or” used in the disclosure is intended not to be an exclusive OR.

A radio frame may be formed of one or more frames in the time domain. In the time domain, each of the one or more frames may be referred to as a subframe. A subframe may further be formed of one or more slots in the time domain. A subframe may be a fixed time length (e.g., 1 ms) that does not depend on numerology.

The numerology may be a communication parameter to be applied to at least one of transmission or reception of a signal or a channel. The numerology may represent, for example, at least one of a subcarrier spacing (SCS: SubCarrier Spacing), a bandwidth, a symbol length, a cyclic prefix length, a transmission time interval (TTI: Transmission Time Interval), a symbol number per TTI, a radio frame configuration, a specific filtering process performed by a transceiver in a frequency domain, a specific windowing process performed by a transceiver in a time domain, etc.

A slot may be formed of, in a time domain, one or more symbols (OFDM (Orthogonal Frequency Division Multiplexing) symbols, SC-FDMA (Single Carrier Frequency Division Multiple Access) symbols, etc.). A slot may be a unit of time based on the numerology.

A slot may include a plurality of mini-slots. In a time domain, each mini-slot may be formed of one or more symbols. A mini-slot may also be referred to as a sub-slot. A mini-slot may be formed of fewer symbols than those of a slot. The PDSCH (or PUSCH) transmitted in a unit of time that is greater than a mini-slot may be referred to as PDSCH (or PUSCH) mapping type A. The PDSCH (or PUSCH) transmitted using a mini-slot may be referred to as PDSCH (or PUSCH) mapping type B.

Each of the radio frame, subframe, slot, mini-slot, and symbol represents a time unit for transmitting a signal. The radio frame, subframe, slot, mini-slot, and symbol may be called by respective different names.

For example, one subframe may be referred to as a transmission time interval (TTI: Transmission Time Interval), a plurality of consecutive subframes may be referred to as TTI, or one slot or one mini-slot may be referred to as TTI. Namely, at least one of a subframe and TTI may be a subframe (1 ms) in the existing LTE, may be a time interval shorter than 1 ms (e.g., 1 to 13 symbols), or a time interval longer than 1 ms. Note that the unit representing the TTI may be referred to as a slot, a mini-slot, etc., instead of a subframe.

Here, the TTI refers to, for example, the minimum time unit of scheduling in radio communication. For example, in the LTE system, the base station performs scheduling for allocating radio resources (such as a frequency bandwidth, transmission power, etc., that can be used in each terminal 20) in units of TTIs to each terminal 20. Note that the definition of the TTI is not limited to this.

The TTI may be a transmission time unit, such as a channel coded data packet (transport block), a code block, a codeword, etc., or may be a processing unit for scheduling, link adaptation, etc. Note that, when a TTI is provided, a time interval (e.g., a symbol number) onto which a transport block, a code block, or a code ward is actually mapped may be shorter than the TTI.

Note that, when one slot or one mini-slot is referred to as a TTI, one or more TTIs (i.e., one or more slots or one or more mini-slots) may be the minimum time unit of scheduling. Additionally, the number of slots (the number of mini-slots) forming the minimum time unit of scheduling may be controlled.

A TTI with a time length of 1 ms may be referred to as an ordinary TTI (TTI in LTE Rel. 8-12), a normal TTI, a long TTI, an ordinary subframe, a normal subframe, a long subframe, a slot, etc. A TTI that is shorter than a normal TTI may be referred to as a shortened TTI, a short TTI, a partial TTI (partial TTI or fractional TTI), a shortened subframe, a short subframe, a mini-slot, a sub-slot, a slot, etc.

Note that a long TTI (e.g., a normal TTI, a subframe, etc.) may be replaced with a TTI with a time length exceeding 1 ms, and a short TTI (e.g., a shortened TTI, etc.) may be replaced with a TTI with a TTI length that is shorter than the TTI length of the long TTI and longer than or equal to 1 ms.

A resource block (RB) is a resource allocation unit in the time domain and the frequency domain, and may include one or more consecutive subcarriers in the frequency domain. A number of subcarriers included in a RB may be the same irrespective of numerology, and may be 12, for example. The number of subcarriers included in a RB may be determined based on numerology.

Additionally, the resource block may include one or more symbols in the time domain, and may have a length of one slot, one mini-slot, one subframe, or one TTI. Each of one TTI and one subframe may be formed of one or more resource blocks.

Note that one or more RBs may be referred to as a physical resource block (PRB: Physical RB), a subcarrier group (SCG: Sub-Carrier Group), a resource element group (REG: Resource Element Group), a PRB pair, a RB pair, etc.

Additionally, a resource block may be formed of one or more resource elements (RE: Resource Element). For example, 1 RE may be a radio resource area of 1 subcarrier and 1 symbol.

A bandwidth part (BWP: Bandwidth Part) (which may also be referred to as a partial bandwidth, etc.) may represent, in a certain carrier, a subset of consecutive common RB (common resource blocks) for a certain numerology. Here, the common RB may be specified by an index of a RB when a common reference point of the carrier is used as a reference. A PRB may be defined in a BWP, and may be numbered in the BWP.

The BWP may include a BWP for UL (UL BWP) and a BWP for DL (DL BWP). For a UE, one or more BWPs may be configured within one carrier.

At least one of the configured BWPs may be active, and the UE is may not assume that a predetermined signal/channel is communicated outside the active BWP. Note that “cell,” “carrier,” etc. in the present disclosure may be replaced with “BWP.”

The structures of the above-described radio frame, subframe, slot, mini-slot, symbol, etc., are merely illustrative. For example, the following configurations can be variously changed: the number of subframes included in the radio frame; the number of slots per subframe or radio frame; the number of mini-slots included in the slot; the number of symbols and RBs included in the slot or mini-slot; the number of subcarriers included in the RB; and the number of symbols, the symbol length, the cyclic prefix (CP: Cyclic Prefix) length, etc., within the TTI.

In the present disclosure, for example, if an article is added by translation, such as a, an, and the in English, the present disclosure may include that the noun following the article is plural.

In the present disclosure, the term “A and B are different” may imply that “A and B are different from each other.” Note that the term may also imply “each of A and B is different from C.” The terms, such as “separated,” “coupled,” etc., may also be interpreted similarly.

While the present disclosure is described in detail above, those skilled in the art will appreciate that the present disclosure is not limited to the embodiments described in the present disclosure. The disclosure may be implemented as modifications and variations without departing from the gist and scope of the disclosure as defined by the claims. Accordingly, the description of the present disclosure is for illustrative purposes only and is not intended to have any restrictive meaning with respect to the present disclosure.

### LIST OF REFERENCE SYMBOLS

10 base station
110 transmitting unit
120 receiving unit
130 control unit
20 terminal
210 transmitting unit
220 receiving unit
230 control unit
1001 processor
1002 storage device
1003 auxiliary storage device
1004 communication device
1005 input device
1006 output device

1. A terminal comprising:
a receiving unit that receives scheduling information; and
a control unit that continues, in a case where the receiving unit receives the scheduling information within a delay time for switching a maximum number of Multiple-Input and Multiple-Output (MIMO) layers, an operation for switching the maximum number of MIMO layers and ignores the scheduling information.

2. The terminal according to claim 1, wherein the delay time is specified for each of
a case where the switching of the maximum number of the MIMO layers is indicated by using Radio Resource Control (RRC) signaling,
a case where the switching of the maximum number of the MIMO layers is indicated by using Downlink Control Information (DCI), and
a case where the switching of the maximum number of the MIMO layers is performed based on a timer.

3. The terminal according to claim 1, wherein the control unit performs the operation to switch the maximum number of the MIMO layers as a part of an operation for switching a Bandwidth Part.

4. The terminal according to claim 1, wherein the delay time is specified for each of a Frequency Range 1 (FR1) and a Frequency Range 2 (FR2).

5. A communication method executed by a terminal, the method comprising:
receiving scheduling information; and
continuing, in a case where the receiving receives the scheduling information within a delay time for switching a maximum number of Multiple-Input and Multiple-Output (MIMO) layers, an operation for switching the maximum number of MIMO layers and ignoring the scheduling information.
